(19) United States
(12) Patent Application Publication
(10) Pub. No.: US 2011/0181248 A1
(43) Pub. Date: Jul. 28, 2011

(54) BATTERY MANAGEMENT APPARATUS

(75) Inventors: DENNIS BERGER, Sersheim (DE); Markus Atz, Weingarten (DE); Juergen Hofmann, Korntal-Muenchingen (DE)

(73) Assignee: Dr. Ing. h.c. F. Porsche Aktiengesellschaft, Stuttgart (DE)

(21) Appl. No.: 12/984,102

(22) Filed: Jan. 4, 2011

(30) Foreign Application Priority Data
Jan. 26, 2010 (DE) 10 2010 005 666.9

(51) Int. Cl. H02J 7/04

(52) U.S. Cl. 320/118

(57) ABSTRACT

A battery management apparatus for a motor vehicle battery, wherein the battery includes a plurality of series-connected battery cells, wherein the apparatus includes a device for determining a cell voltage for each battery cell in the battery, wherein the apparatus compares the determined cell voltages of the battery cells with one another and processes them such that, if the cell voltage of at least one battery cell is greater than a first limit value and, furthermore, if the cell voltage of at least one battery cell differs from the cell voltage of the or each other battery cell by more than a defined second limit value, the apparatus uses the lowest cell voltage of the battery cells as the reference voltage, and it discharges the or each other battery cell with a higher cell voltage in order to balance the voltage between the battery cells at the reference voltage.

### CROSS REFERENCE TO RELATED APPLICATION

This U.S. patent application claims priority to German Application DE 10 2010 005 666.9, filed Jan. 26, 2010, which is incorporated by reference herein in its entirety.

### FIELD OF THE INVENTION

The invention relates to a battery management apparatus for a motor vehicle battery.

### BACKGROUND OF THE INVENTION

It is already known from practice that a motor vehicle battery comprises a plurality of series-connected battery cells, which together provide a voltage potential for operating electrical loads in the motor vehicle. Particularly when the battery cells connected in series are based on lithium technology, it is desirable for the individual battery cells in the motor vehicle battery to be at the same voltage level and accordingly to have approximately the same cell voltage. This can be ensured with the aid of a battery management apparatus, although no battery management apparatus has been known until now which has made it possible in a simple, effective and battery-detecting manner to keep the series-connected battery cells of a motor vehicle battery at the same voltage level.

The invention relates to the problem of providing a novel battery management apparatus.

This problem is solved by a battery management apparatus as disclosed herein.

### SUMMARY OF THE INVENTION

According to aspects of the invention, the battery management apparatus comprises a device with the aid of which a cell voltage can be determined for each battery cell in the motor vehicle battery, wherein the battery management apparatus compares the determined cell voltages of the battery cells with one another and processes them such that, if the cell voltage of at least one battery cell is greater than a first limit value and, furthermore, if the cell voltage of at least one battery cell differs from the cell voltage of the or each other battery cell by more than a defined second limit value, the battery management apparatus uses the lowest cell voltage of the battery cells as the reference voltage, and it discharges the or each other battery cell with a higher cell voltage in order to balance the voltage between the battery cells at the reference voltage.

The battery management apparatus according to aspects of the invention determines a cell voltage for each battery cell of the motor vehicle battery in a defined measurement cycle or measurement interval, and processes the cell voltages such that, if the cell voltage of at least one battery cell is greater than the first limit value and, furthermore, if the cell voltage of one battery cell differs from the cell voltage of the or each other battery cell by more than the defined second limit value, the lowest cell voltage of the battery cells is used as the reference voltage, in order to discharge the battery cells with a higher cell voltage to the reference voltage in order to balance the voltage between the battery cells.

This makes it possible in a simple and effective manner to keep the individual battery cells in a motor vehicle battery at the same voltage level.

However, this voltage balancing is carried out only when the cell voltage of at least one battery cell is greater than the first limit value and when, furthermore, the cell voltage of at least one battery cell differs from the cell voltages of the or each other battery cell by more than the defined second limit value.

The battery management apparatus preferably processes the cell voltage of the battery cells together with one another such that, if the cell voltages of all the battery cells are less than the first limit value, the battery management apparatus does not balance the cell voltages of the battery cells.

According to one advantageous development of the invention, if the cell voltage of at least one battery cell is greater than a third limit value, the battery management apparatus determines the cell voltages of the battery cells in a first, relatively short measurement cycle or measurement interval. In this case, the third limit value preferably corresponds to that the first limit value. This makes it possible to protect the motor vehicle battery, since the cell voltages are determined in the first, relatively short measurement cycle or measurement interval only when the cell voltage of at least one battery cell is greater than the third limit value, which preferably corresponds to the first limit value.

According to a further advantageous development of the invention, if none of the cell voltages of the battery cells differs from the cell voltages of the other battery cells by more than the second limit value for a defined time period, the battery management apparatus determines the cell voltage in a second, relatively long measurement cycle or measurement interval. In this case, it is likewise possible to protect the motor vehicle battery by lengthening the measurement cycle.

### BRIEF DESCRIPTION OF THE DRAWINGS

Preferred developments of the invention will become evident from the dependent claims and the following description. Exemplary embodiments of the invention will be explained in more detail with reference to the drawing, without being restricted thereto. In this case:

FIG. 1 shows a schematic illustration of the battery management apparatus, according to aspects of the invention, together with a motor vehicle battery which comprises a plurality of series-connected battery cells.

### DETAILED DESCRIPTION OF THE PREFERRED EMBODIMENTS

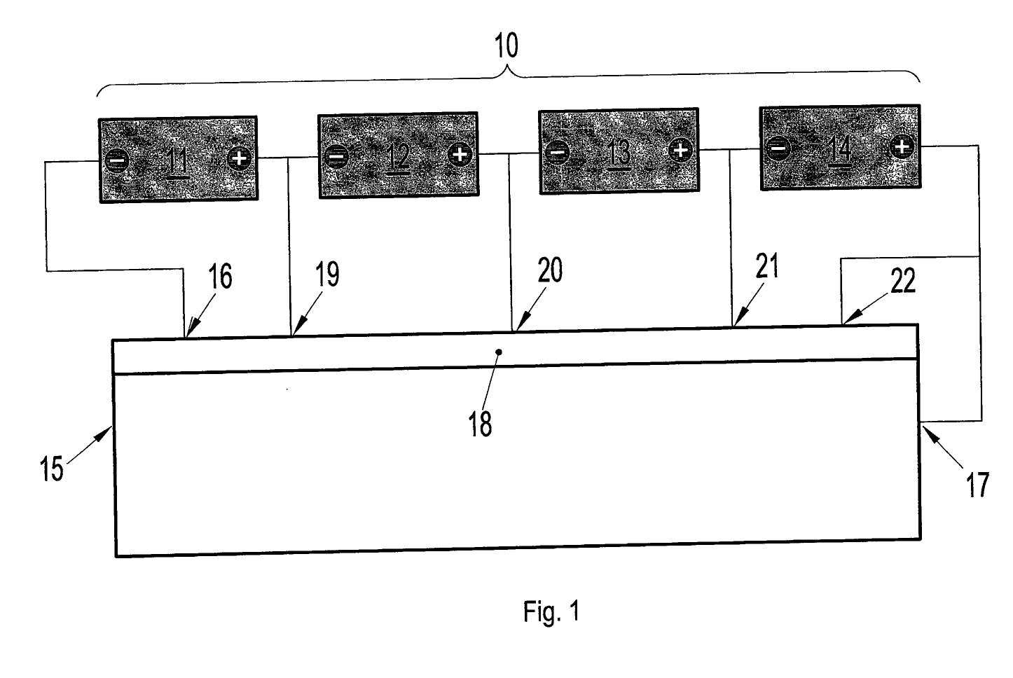

FIG. 1 shows a highly schematic illustration of a motor vehicle battery 10 which comprises a plurality of series-connected battery cells 11, 12, 13 and 14, wherein the motor vehicle battery 10 is connected to a battery management apparatus 15 according to aspects of the invention.

The motor vehicle battery 10 produces a supply voltage between two connections 16 and 17, in order to operate electrical loads in the motor vehicle. The connection 16 is preferably a ground connection, which is associated with a voltage measurement device 18 of the battery management apparatus 15.

The voltage measurement device 18 of the battery management apparatus 15 has further connections 19, 20, 21 and 22 such that each battery cell 11 to 14 in the motor vehicle battery 10 can be connected by its poles to a respective connection 16 to 22 of the voltage measurement device 18.

The voltage measurement device 18 can be used to determine an individual cell voltage by measurement for each battery cell 11 to 14 in the motor vehicle battery 10.

The battery management apparatus 15 compares and processes the individual cell voltages, determined with the aid of the voltage measurement device 18, of the battery cells 11 to 14 such that, if the cell voltage of at least one battery cell 11, 12, 13 or 14 is greater than a first limit value and if, furthermore, the cell voltage of at least one battery cell 11, 12, 13 or 14 differs from the cell voltage of the or each other battery cell by more than a defined, second limit value, the battery management apparatus 15 uses the lowest cell voltage of the battery cells 11 to 14 as a reference voltage, and discharges the or each other battery cell with a higher cell voltage to the reference voltage, in order in this way to provide voltages balancing between the battery cells 11 to 14, and to keep them at the same voltage level.

If the cell voltages of all the battery cells 11 to 14 are less than the first limit value, no voltage balancing is preferably carried out between the battery cells 11 to 14. Then, the battery management apparatus 15 processes the cell voltage of the battery cells 11 to 14 with one another such that, if the cell voltages of all the battery cells 11 to 14 are less than the first limit value, it no longer balances the cell voltages of the battery cells 11 to 14. However, if the cell voltage of one or more battery cells 11 to 14 is greater than the first limit value, the voltage balancing according to aspects of the invention to the reference voltage is carried out if the cell voltage of at least one battery cell 11 to 14 differs from the cell voltage of the or each other battery cell by the defined, second limit value.

Alternatively, it is also possible for the battery management apparatus 15 to carry out the voltage balancing as defined above to the reference voltage, specifically to the respective lowest cell voltage, only if the cell voltages of all the battery cells 11 to 14 are greater than the first limit value and, furthermore, the cell voltage of at least one battery cell 11 to 14 differs from the cell voltages of the or each other battery cell by more than the defined, second limit value. In this case, the voltage balancing between the battery cells 11 to 14 would no longer be carried out if only one cell voltage of one battery cell were less than the first limit value.

According to one advantageous development of the invention, the battery management apparatus 15, specifically the voltage measurement device 18 of it, then determines the cell voltages of the battery cells 11 to 14 in a first, relatively short measurement cycle or measurement interval, and processes these measured values with one another in this first, relatively short measurement cycle or measurement interval, if the cell voltage of at least one battery cell 11 to 14 is greater than a third limit value. In this case, the third limit value preferably corresponds to the first limit value, although it may also differ from the first limit value.

The battery management apparatus 15, specifically the voltage measurement device 18 of it, preferably determines the cell voltages in a second, relatively long measurement cycle or measurement interval if the cell voltages of all the battery cells 11 to 14 are less than the third limit value. The processing of the cell voltages in the battery management apparatus 15 is then also carried out in this second, relatively long measurement cycle or measurement interval. This makes it possible to lengthen the measurement cycle or the measurement interval if the battery cells 11 to 14 have been discharged relatively severely, and thus to protect the battery cells in that, if the battery cells 11 to 14 are in a relatively low state of charge, the cell voltages are measured at longer time intervals. As already mentioned, the cell voltages are detected i n the first, relatively short measurement cycle or measurement interval if at least one cell voltage of the battery cells 11 to 14 is greater than the third limit value.

Alternatively, it is also possible to carry out the measurement of the cell voltages in the first relatively short measurement cycle only if the cell voltages of all the battery cells 11 to 14 are greater than the third limit value and then to change to the second, relatively long measurement cycle or measurement interval if the cell voltage of at least one battery cell 11 to 14 falls below the third limit value.

Further protection of the battery cells 11 to 14 by means of the battery management apparatus 15 is possible in that, if none of the cell voltages of the battery cells 11 to 14 differs from the cell voltages of the other battery cells by more than the second limit value, the battery management apparatus 15 determines the cell voltages in the second, relatively long measurement cycle or measurement interval.

Therefore, if it is found that the cell voltages of the battery cells are at approximately the same voltage level for a defined time interval, then the measurement cycle or the measurement interval can be lengthened.

The battery management apparatus 15 according to aspects of the invention is used in particular when the motor vehicle battery, specifically the battery cells 11 to 14 in it, are based on lithium technology and are in the form of lithium-iron-phosphate battery cells.

1-8. (canceled)

9. A battery management apparatus for a motor vehicle battery including a plurality of series-connected battery cells, said battery management apparatus comprising:
a device for determining a cell voltage for each battery cell in the motor vehicle battery,
wherein the battery management apparatus is configured to (i) compare the determined cell voltages of the battery cells with one another, and (ii) process the determined cell voltages of the battery cells such that, if the cell voltage of at least one battery cell is greater than a first limit value and, furthermore, if the cell voltage of at least one battery cell differs from the cell voltage of the or each other battery cell by more than a defined second limit value, the battery management apparatus uses the lowest cell voltage of the battery cells as the reference voltage and discharges the or each other battery cell with a higher cell voltage in order to balance the voltage between the battery cells at the reference voltage.

10. The battery management apparatus as claimed in claim 9, wherein said battery management apparatus is configured to process the cell voltages of the battery cells such that, if the cell voltages of all the battery cells are greater than the first limit value and, furthermore, if the cell voltage of at least one battery cell differs from the cell voltage of the or each other battery cell by more than the defined second limit value, the battery management apparatus uses the lowest cell voltage as the reference voltage, and discharges the or each other battery cell with a higher cell voltage to the reference voltage.

11. The battery management apparatus as claimed in claim 9, wherein said battery management apparatus is configured to process the cell voltage of the battery cells such that, if the cell voltages of all the battery cells are less than the first limit value, the battery management apparatus does not balance the cell voltages of the battery cells.

12. The battery management apparatus as claimed in claim 9, wherein if the cell voltage of at least one battery cell is greater than a third limit value, said battery management apparatus is configured to (i) determine the cell voltages of the battery cells in a first, relatively short measurement cycle, (ii) compare the cell voltages of the battery cells with one another, and (iii) process the cell voltages of the battery cells.

13. The battery management apparatus as claimed in claim 12, wherein if the cell voltages of all the battery cells are greater than the third limit value, said battery management apparatus is configured to (i) determine the cell voltages in the first, relatively short measurement cycle, (ii) compare the cell voltages of the battery cells with one another, and (iii) process the cell voltages of the battery cells.

14. The battery management apparatus as claimed in claim 12, wherein if the cell voltages of all the battery cells are less than the third limit value, said battery management apparatus is configured to (i) determine the cell voltages in a second, relatively long measurement cycle, (ii) compare the cell voltages of the battery cells with one another, and (iii) process the cell voltages of the battery cells.

15. The battery management apparatus as claimed in claim 12, wherein the third limit value corresponds to the first limit value.

16. The battery management apparatus as claimed in claim 12, wherein if none of the cell voltages of the battery cells differs from the cell voltages of the other battery cells by more than the second limit value for a defined time period, said battery management apparatus is configured to (i) determine the cell voltages in a second, relatively long measurement cycle, (ii) compare the cell voltages of the battery cells with one another, and (iii) process the cell voltages of the battery cells.
